(19) United States
(12) Patent Application Publication
(10) Pub. No.: US 2022/0391643 A1
(43) Pub. Date: Dec. 8, 2022

(54) METHOD OF INTERACTIVELY IMPROVING AN AI MODEL GENERALIZATION USING AUTOMATED FEATURE SUGGESTION WITH A USER

(71) Applicant: Katam.ai Inc., Clyde Hill, WA (US)

(72) Inventors: Riham Mansour, Redmond, WA (US); Patrice Simard, Clyde Hill, WA (US)

(73) Assignee: Katam.ai Inc., Clyde Hill, WA (US)

(21) Appl. No.: 17/410,608

(22) Filed: Aug. 24, 2021

Related U.S. Application Data
(63) Continuation-in-part of application No. 17/337,726, filed on Jun. 3, 2021.

(51) Int. Cl. G06K 9/62; G06N 20/00; G06N 5/02

(52) U.S. Cl. CPC G06K 9/6263; G06N 20/00; G06N 5/02; G06K 9/6253

(57) ABSTRACT

A processor-implemented method includes (i) selecting initial features using a machine learning algorithm with a training data, (ii) automatically generating selected candidate features for an artificial intelligence (AI) model from the initial features, wherein the selected candidate features are generated from the training data or selected from a repository of curated features, (iii) automatically selecting a subset from selected candidate features and augmenting them to obtain suggested features based on an external knowledge source, (iv) presenting the suggested features to a user based on an improvement in the objective function of the AI model caused by addition of the suggested features to the AI model, (v) enabling the user to validate the suggested features, wherein the suggested features are validated by the user to improve a generalization of the AI model, and (vi) adding validated suggested features to the AI model to improve the generalization of the AI model.

### BACKGROUND

### Technical Field

Embodiments of this disclosure generally relate to predictive artificial intelligence (AI) models, and more particularly, to a method of interactively improving a generalization of an AI model using automated feature suggestion with a user.

### Description of the Related Art

A basic principle of machine learning is to minimize a cost function over a training set, with the goal that it will produce similar performance over unseen data like a test set. The basic principle assumes that the input is processed in a predictable and constant fashion, and what is being changed is either the data (getting as many training examples as possible) or the trainable parameters through training. If adding data and training are the only two variables, it is advantageous to start with a large feature space to ensure that the model is able to separate the data. For example, if the problem is to detect the probability of hospitalization for a patient with a high fever, a lot of historical data representing cases of patients, their temperatures, and whether or not they were hospitalized may be considered. A problem arises when features are to be provided to the machine learning model. If just the temperature is provided, the machine learning algorithm cannot learn correlation with age, heart problems, diabetes, and so on. If every possible piece of information is provided, such as eye color or high school grades, a very large number of cases are needed to eliminate spurious accidental correlation. If there are too few cases, accidental and incorrect correlations may be observed. For instance, on a training set of size 1000, a learning algorithm may discover that when the patient's high school GPA is between 2.6 and 3.1 and the temperature is between 100.0 and 100.5, the probability of hospitalization is 90%. This overfitting of the training data is called over-training. With a training set of size 1,000,000, these spurious correlations disappear and more meaningful correlation such as diabetes, heart conditions, and pneumonia history may be detected.

In an existing approach, automatic methods of selecting features that best fit the training data are utilized. A brute force approach for selecting features may be utilized that may estimate all possible combinations of features to fit the training data. A disadvantage of the existing approach is that it works well for the training data but for data other than the training data, it is unable to consistently produce accurate results. Because the existing approach is evaluated on finite samples, evaluation of a learning algorithm trained using the existing approach may be sensitive to sampling error. As a result, measurements of prediction error on the training data may not provide much information about predictive ability on new data and cause overfitting.

The traditional machine learning (ML) approach to this problem is to provide a large set of features and match it with a large amount of labelled data. This works well for the category of problems where labelled data is easy to come by or the problem is important enough to justify the data collection cost. But for a smaller problem, when the user cannot afford to label more than a thousand labels, over-training is a significant risk.

Therefore, there remains a need for cost-effective ML training.

### SUMMARY

In view of the foregoing, embodiments herein provide a processor-implemented method of interactively improving a generalization of an artificial intelligence (AI) model using automated feature suggestion. The method includes (i) selecting an initial set of features using a machine learning algorithm with a training data to improve an objective function of the AI model, (ii) automatically generating a plurality of selected candidate features for the AI model from the initial set of features, wherein the plurality of selected candidate features are generated from the training data or selected from a repository of curated features, (iii) automatically selecting a subset of the plurality of selected candidate features and augmenting the subset of the plurality of selected candidate features to obtain suggested features based on a source of knowledge that is external to the training data, (iv) presenting the suggested features to the user based on the improvement in the objective function of the AI model caused by addition of the suggested features in the AI model, (v) enabling the user to validate at least one of the suggested features to obtain at least one validated suggested feature, wherein the at least one validated suggested feature is validated by the user to improve the generalization of the AI model, and (vi) adding the at least one validated suggested feature to the AI model to improve the generalization of the AI model.

Validating the suggested features based on the user input to obtain validated suggested features allows the user to inject domain knowledge to help the AI model generalize, instead of fitting a distribution of the training data into the AI model.

In some embodiments, the automatically generating the plurality of selected candidate features is triggered if the AI model produces an error in classifying the training data based on a set of provided features.

In some embodiments, the improvement is determined by (a) measuring the performance of the objective function of the AI model or a first count of errors in the training set, before addition of at least one selected candidate feature, to obtain a first measurement, (b) measuring the performance of the objective function of the AI model or a second count of errors in the training set, after addition of at least one selected candidate feature, to obtain a second measurement, and (c) subtracting the second measurement from the first measurement to determine the improvement.

In some embodiments, the machine learning algorithm used to select the initial set of features produces errors in the training data before the validated suggested features are added to the AI model.

In some embodiments, a rejection by the user is processed to reject at least one of the suggested features to obtain at least one rejected suggested feature, wherein the rejected suggested feature is not added to the AI model, and the rejection of the rejected suggested feature is taken into account by the AI model for generating additional suggestions of features.

In some embodiments, the suggested features are interactively validated by the user by adding or rejecting the suggested features until no further errors are produced in the training data.

In some embodiments, the selected candidate features comprise nGrams that are filtered using unsupervised data that is selected based on at least one of an inverse document frequency method, synonyms of nGrams and the repository of curated features.

In another aspect, there is provided a processor implemented method of interactively improving a generalization of an AI model using automated composite feature suggestion with a user. The method includes (i) generating a plurality of composite features to improve an objective function of the AI model, wherein each of the plurality of composite features comprises a combination of at least a first feature and a second feature of the AI model, (ii) automatically selecting a subset of the plurality of composite features and augmenting the subset of the plurality of composite features to obtain suggested features, (iii) presenting the suggested features to the user based on an improvement in the objective function of the AI model caused by addition of the suggested features in the AI model, (iv) enabling the user to validate at least one of the suggested features to obtain at least one validated suggested feature, wherein the at least one validated suggested feature is validated by the user to improve the generalization of the AI model, and (v) adding the at least one validated suggested feature to the AI model to improve the generalization of the AI model.

In some embodiments, automatically selecting comprises discarding at least one composite feature of the plurality of composite features if the first feature and the second feature do not satisfy a positional constraint with respect to each other, wherein the at least one composite feature comprises the first feature and the second feature.

In another aspect, there is provided a system for interactively improving a generalization of an AI model using automated feature suggestion with a user comprising a processor and a non-transitory computer readable storage medium storing one or more sequences of instructions, which when executed by the processor, performs a method that includes (i) selecting an initial set of features using a machine learning algorithm on a training data to improve an objective function of the AI model (ii) automatically generating a plurality of selected candidate features for the AI model from the initial set of features, wherein the plurality of selected candidate features are generated from the training data or selected from a repository of curated features, (iii) automatically selecting a subset of the plurality of selected candidate features and augmenting the subset of the plurality of selected candidate features to obtain suggested features based on a source of knowledge that is external to the training data, (iv) presenting the suggested features to a user based on an improvement in the objective function of the AI model caused by addition of the suggested features in the AI model, (v) enabling the user to validate at least one of the suggested features to obtain at least one validated suggested feature, wherein the at least one validated suggested feature is validated by the user to improve the generalization of the AI model, and (vi) adding the at least one validated suggested feature to the AI model to improve the generalization of the AI model.

In some embodiments, the automatically generating the plurality of selected candidate features is triggered if the AI model produces an error in classifying the training data based on a set of provided features.

In some embodiments, the improvement is determined by (a) measuring the performance of the objective function of the AI model or a first count of errors in the training set, before addition of at least one selected candidate feature, to obtain a first measurement, (b) measuring the performance of the objective function of the AI model or a second count of errors in the training set, after addition of at least one selected candidate feature, to obtain a second measurement, and (c) subtracting the second measurement from the first measurement to determine the improvement.

In some embodiments, the machine learning algorithm used to select the initial set of features produces errors in the training data before the validated suggested features are added to the AI model.

In some embodiments, a rejection by the user is processed to reject at least one of the suggested features to obtain at least one rejected suggested feature, wherein the rejected suggested feature is not added to the AI model, and the rejection of the rejected suggested feature is taken into account by the AI model for generating additional suggestions of features.

In some embodiments, the suggested features are interactively validated by the user by adding or rejecting the suggested features until no further errors are produced in the training data.

In some embodiments, the selected candidate features comprise nGrams that are filtered using unsupervised data that is selected based on at least one of an inverse document frequency method, synonyms of nGrams and the repository of curated features.

In some embodiments, the generalization of the AI model is interactively improved using automated composite feature suggestion with the user, including (i) generating a plurality of composite features to improve the objective function of the AI model, wherein each of the plurality of composite features comprises a combination of at least a first feature and a second feature of the AI model, (ii) automatically selecting a subset of the plurality of composite features and augmenting the subset of the plurality of composite features to obtain suggested features, (iii) presenting the suggested features to the user based on an improvement in the objective function of the AI model caused by addition of the suggested features in the AI model, (iv) enabling the user to validate at least one of the suggested features to obtain at least one validated suggested feature, wherein the at least one validated suggested feature is validated by the user to improve the generalization of the AI model, and (v) adding the at least one validated suggested feature to the AI model to improve the generalization of the AI model.

In some embodiments, automatically selecting comprises discarding at least one composite feature of the plurality of composite features if the first feature and the second feature do not satisfy a positional constraint with respect to each other, wherein the at least one composite feature comprises the first feature and the second feature.

In yet another aspect, there is provided one or more non-transitory computer readable storage mediums storing one or more sequences of instructions, which when executed by one or more processors, causes a method of interactively improving a generalization of an AI model using automated feature suggestion with a user, the method includes (i) selecting an initial set of features using a machine learning algorithm with a training data to improve an objective function of the AI model (ii) automatically generating a plurality of selected candidate features for the AI model from the initial set of features, wherein the plurality of selected candidate features are generated from the training data or selected from a repository of curated features, (iii) automatically selecting a subset of the plurality of selected candidate features and augmenting the subset of the plurality of selected candidate features to obtain suggested features based on a source of knowledge that is external to the training data, (iv) presenting the suggested features to the user based on an improvement in the objective function of the AI model caused by addition of the suggested features in the AI model, (v) enabling the user to validate at least one of the suggested features to obtain at least one validated suggested feature, wherein the at least one validated suggested feature is validated by the user to improve the generalization of the AI model, and (vi) adding the at least one validated suggested feature to the AI model to improve the generalization of the AI model.

In some embodiments, the improvement is determined by (a) measuring the performance of the objective function of the AI model or a first count of errors in the training set, before addition of at least one selected candidate feature, to obtain a first measurement, (b) measuring the performance of the objective function of the AI model or a second count of errors in the training set, after addition of at least one selected candidate feature, to obtain a second measurement, and (c) subtracting the second measurement from the first measurement to determine the improvement.

In some embodiments, the AI model is interactively improved using automated composite feature suggestion, including (i) generating a plurality of composite features to improve the objective function of the AI model, wherein each of the plurality of composite features comprises a combination of at least a first feature and a second feature of the AI model, (ii) automatically selecting a subset of the plurality of composite features and augmenting the subset of the plurality of composite features to obtain suggested features, (iii) presenting the suggested features to the user based on an improvement in the objective function of the AI model caused by addition of the suggested features in the AI model, (iv) enabling the user to validate at least one of the suggested features to obtain at least one validated suggested feature, wherein the at least one validated suggested feature is validated by the user to improve the generalization of the AI model, and (v) adding the at least one validated suggested feature to the AI model to improve the generalization of the AI model.

In some embodiments, the selected candidate features comprise nGrams that are filtered using unsupervised data that is selected based on at least one of an inverse document frequency method, synonyms of nGrams and the repository of curated features.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a computing environment in which a computing device is operable to interactively improve a generalization of an artificial intelligence (AI) model using automated feature suggestion with a user according to some embodiments herein;

FIG. 2 is a block diagram of the computing device of FIG. 1 according to some embodiments herein;

FIGS. 3A-C are exemplary screens of the user device of FIG. 1 that illustrates automatically generating selected candidate features for automated feature suggestions for a customer support AI model according to some embodiments herein;

FIG. 4 is an exemplary screenshot of the user device of FIG. 1 that illustrates creating a new composite feature according to some embodiments herein;

FIG. 5 is an interaction-type flow diagram that illustrates a method for interactively improving a generalization of an AI model using automated feature suggestion with a user according to some embodiments herein;

FIG. 6 is a flow diagram that illustrates a method for interactively improving a generalization of an AI model using automated feature suggestion with a user according to some embodiments herein; and

FIG. 7 is a block diagram of a schematic diagram of a device used in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

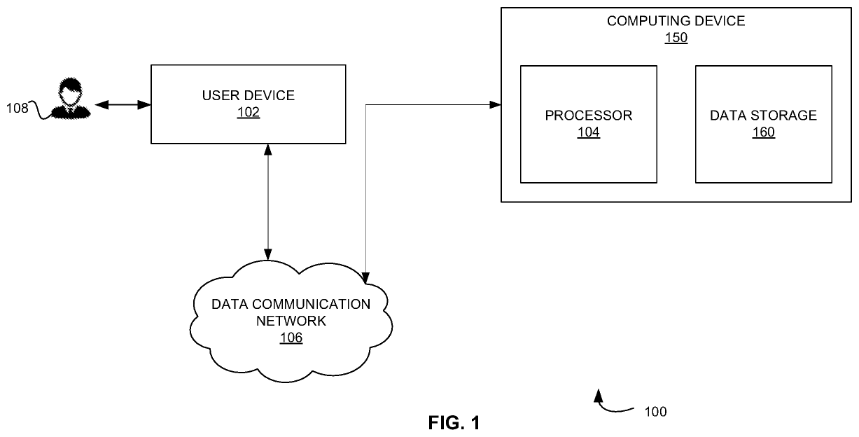

There remains a need for a method of interactively improving an artificial intelligence (AI) model using automated feature suggestion. Referring now to the drawings, and more particularly to FIGS. 1 through 7, where similar reference characters denote corresponding features consistently throughout the figures, preferred embodiments are shown.

FIG. 1 is a block diagram that illustrates a computing environment 100 in which a computing device 150 is operable to interactively improve a generalization of an AI model using automated feature suggestion with a user in accordance with an embodiment of the disclosure. The computing environment includes a user device 102, a computing device 150 having a processor 104 and a data storage 160, and a data communication network 106. In some embodiments, the data communication network 106 is a wired network. In some embodiments, the data communication network 104 is a wireless network. In some embodiments, the data communication network 106 is a combination of a wired network and a wireless network. In some embodiments, the data communication network 106 is the Internet.

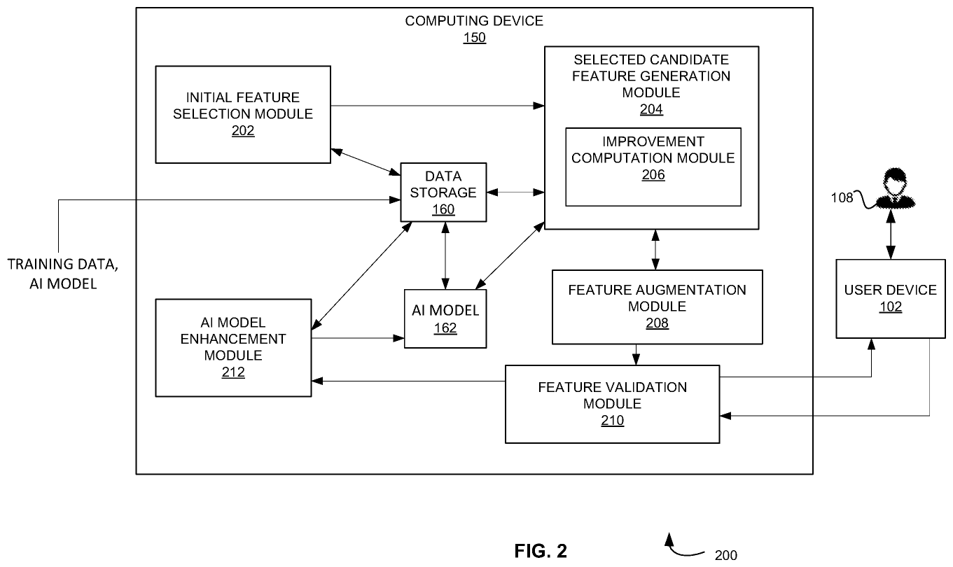

The data storage 160 represents a storage for the AI model and training data, which is accessed by the computing device 150 for interactively improving a generalization of an AI model, shown in FIG. 2, using automated feature suggestion. The computing device 150 is operable to train the AI model. The term “objective function” refers to a function to be maximized or minimized in a specific optimization problem. For example, in machine learning (ML), for a model, M, usually a loss function L (e.g., a mean squared error) is defined, which minimizes, L is the “objective function” of the specific optimization problem, which in this example, is to be minimized. The term “generalization” of an AI model is defined as a measure of how accurately the AI model is able to predict outcome values for previously unseen data. The computing device 150 interacts with the data storage 160 while accessing the training data. The user device 102 receives inputs from a user 108 in a corresponding user interface on the user device 102 to validate one or more suggested features based on a user input to obtain one or more validated suggested features, where the one or more validated suggested features are validated by the user to improve the generalization of the AI model.

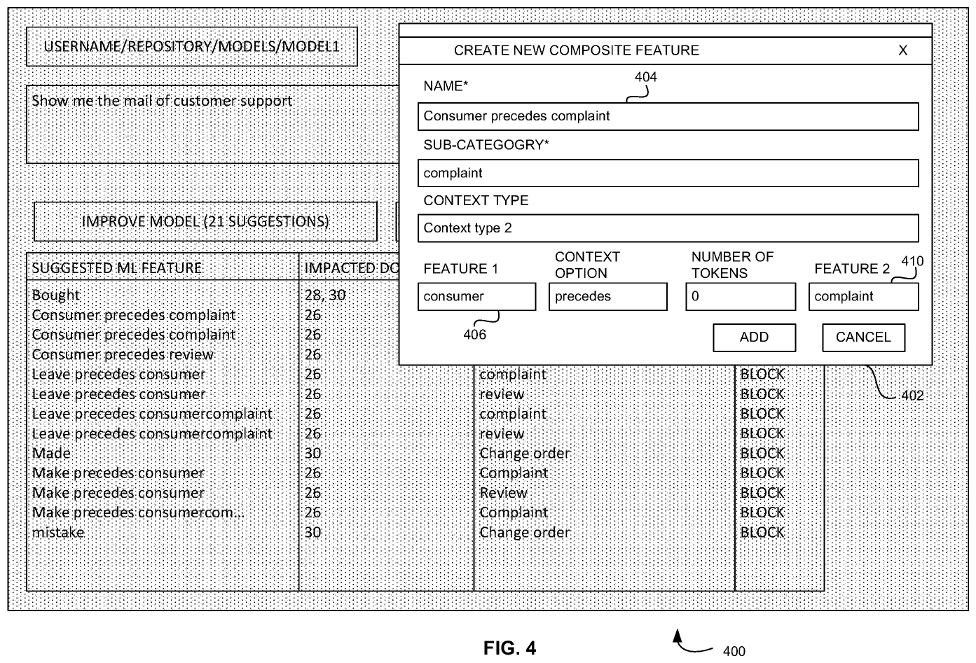

The computing device 150 may be configured to generate a plurality of composite features, wherein each of the plurality of composite features comprises a combination of at least a first feature and a second feature of the AI model. The computing device 150 automatically selects a subset of the plurality of composite features and augmenting the subset of the plurality of composite features to obtain suggested features. In machine learning, a feature is defined as an individual measurable property or characteristic of a phenomenon. A composite feature is defined as a combination of two or more features which may be more informative of the phenomenon than individual features in some cases. As an example, in a scenario where a model is used supporting customer mails, the first feature may be “consumer” which may be informative of a customer being referred to in the data, and the second feature may be “complaint” which may be indicative of a complaint being referred to in the data. Accordingly, the composite feature “customer precedes complaint” may be generated based on the first feature may be “consumer” and the second feature may be “complaint”, which is more informative of the phenomenon of a complaint of a customer. Creating a new composite feature is described in further detail in the description of FIG. 4.

The computing device 150 may be configured to present the suggested features to the user 108 based on an improvement in the objective function of the AI model caused by addition of the suggested features in the AI model. The computing device 150 enables the user to validate one or more of the suggested features to obtain one or more validated suggested features, where the one or more validated suggested features are validated by the user to improve the generalization of the AI model. In some embodiments, the computing device 150 may be configured to add the one or more validated suggested features to the AI model to improve generalization of the AI model.

The computing device 150 validates the suggested features based on the user input to obtain validated suggested features allows the user to inject domain knowledge to help the AI model generalize, instead of fitting a distribution of the training data into the AI model.

FIG. 2 is a block diagram of the computing device 150 of FIG. 1 according to some embodiments herein. The computing device 150 includes the data storage 160 that is connected to an AI model 162, an initial feature selection module 202, a selected candidate feature generation module 204 that includes an improvement computation module 206, a feature augmentation module 208, a feature validation module 210, and an AI model enhancement module 212. The data storage 160 obtains the training data. The feature validation module 210 may be configured to validate, based on the user input that may be obtained from the user 108 via the user device 102, one or more suggested features based on a user input to obtain validated suggested features, where validated suggested features are validated by the user to improve the generalization of the AI model. In an embodiment, the AI model 162 is initially a model with no feature before interactively improving the AI model using automated feature suggestion.

The initial feature selection module 202 selects an initial set of features using a machine learning algorithm with a training data to improve an objective function of the AI model 162. In some embodiments, the machine learning algorithm used to select the initial set of features produces errors in the training data before the validated suggested features are added to the AI model 162. In some embodiments, the machine learning algorithm is a low-capacity machine learning algorithm, which is defined as an algorithm that does not has a capacity to have zero errors on the training data.

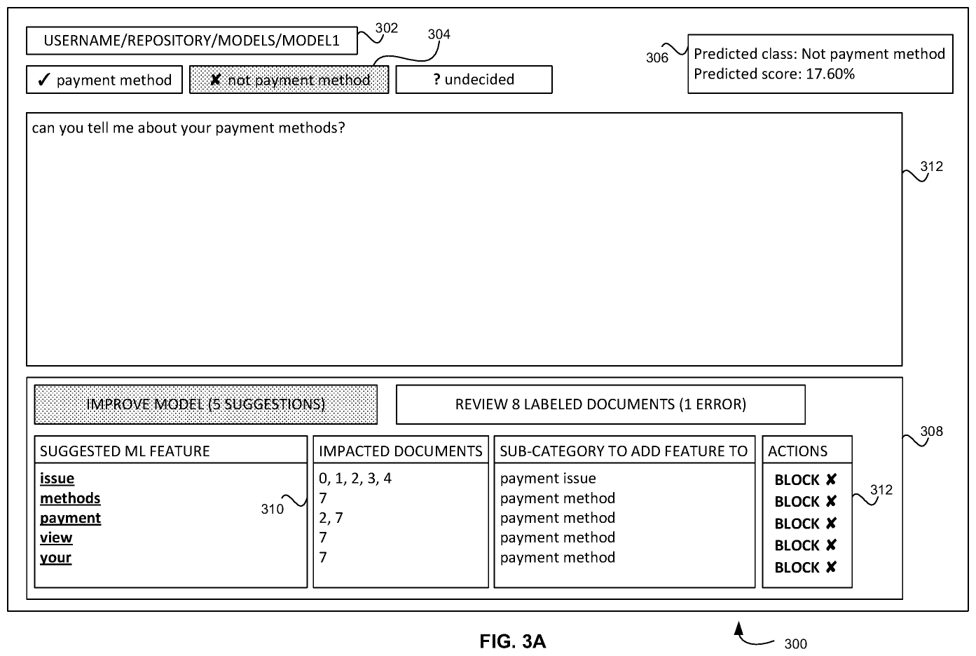

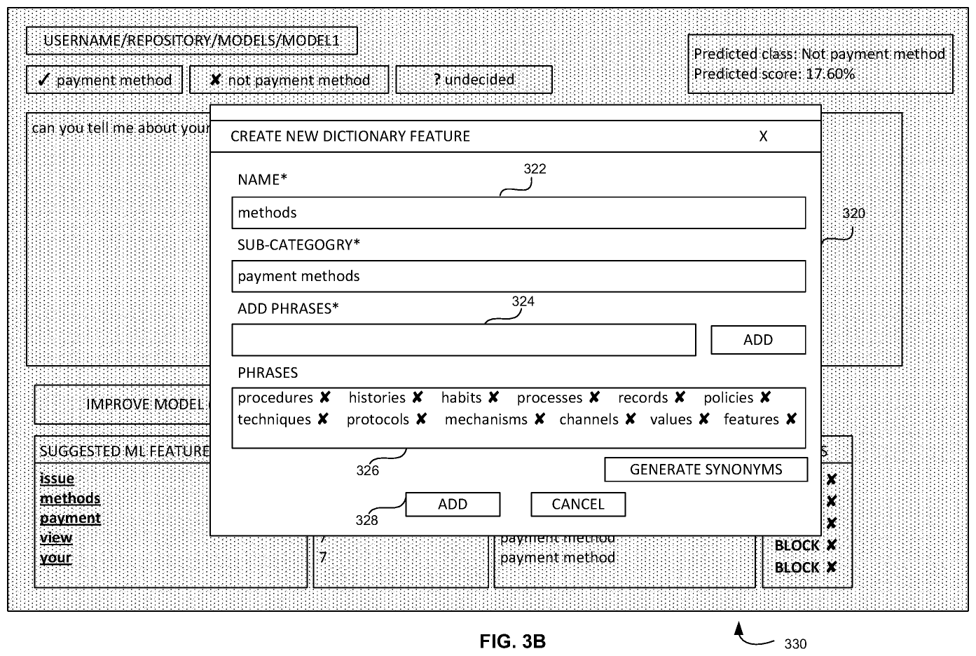

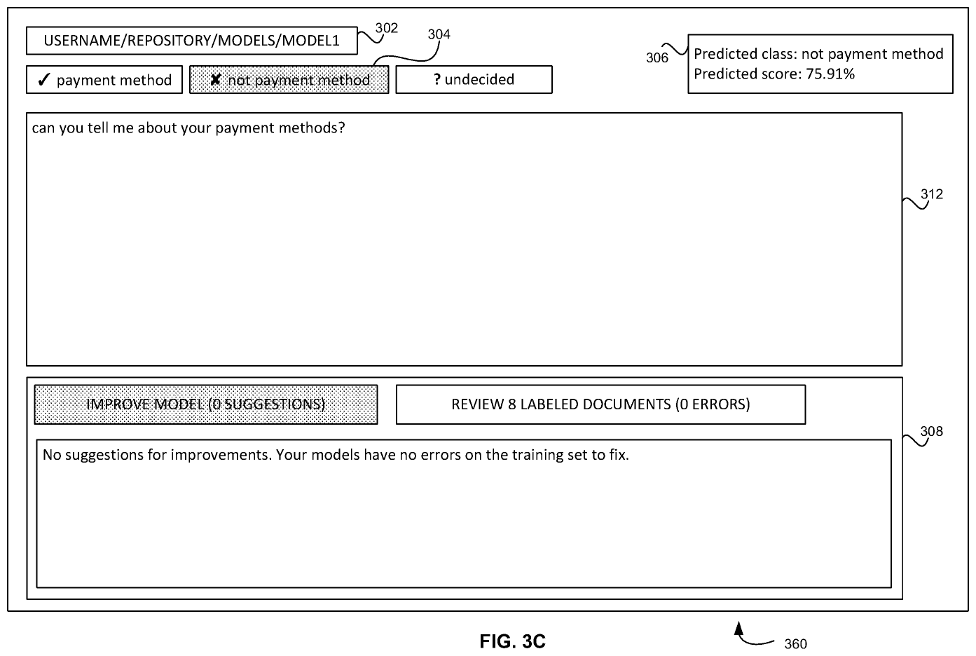

The selected candidate feature generation module 204 automatically generates a plurality of selected candidate features for the AI model 162 from the initial set of features from the initial feature selection module 202, wherein the plurality of selected candidate features are generated from the training data or selected from a repository of curated features. For example, the plurality of selected candidate features may include an “issue” feature, a “methods” feature, a “payment feature” and a “view” feature. Automatically generating the plurality of selected candidate features is further described with respect to the description of FIGS. 3A-C.

The improvement computation module 206 determines an improvement in the objective function of the AI model 162 caused by addition of the suggested features in the AI model 162. The suggested features may be presented to the user 108 based on the improvement in the objective function of the AI model 162 caused by addition of the suggested features in the AI model. The feature augmentation module 208 automatically selects a subset of the plurality of selected candidate features and augments the subset of the plurality of selected candidate features to obtain suggested features based on a source of knowledge that is external to the training data. In some embodiments, the augmenting may be performed using unsupervised learning, deep representation, and bidirectional encoder representations from transformers (BERT)-like model that are adept at generating synonyms while leveraging context. In an embodiment, the improvement computation module 206 may rank the concepts after augmenting the subset of the plurality of selected candidate features or selects the suggested features from the repository of curated features.

The feature validation module 210 may enable the user to validate the suggested features to obtain the one or more validated suggested features, where the one or more validated suggested features are validated by the user to improve the generalization of the AI model. The AI model enhancement module 212 adds the one or more validated suggested features to the AI model 162 to improve the generalization of the AI model.

In some embodiments, the machine learning algorithm used to select the initial set of features produces errors in the training data before the validated suggested features are added to the AI model 162. In some embodiments, a rejection by the user is processed to reject at least one of the suggested features to obtain at least one rejected suggested feature, wherein the rejected suggested feature is not added to the AI model, and the rejection of the rejected suggested feature is taken into account by the AI model for generating additional suggestions of features. In some embodiments, the suggested features are interactively validated by the user by adding or rejecting the suggested features until no further errors are produced in the training data.

In some embodiments, the improvement is determined by (a) measuring the performance of the objective function of the AI model or a first count of errors in the training set, before addition of at least one selected candidate feature, to obtain a first measurement, (b) measuring the performance of the objective function of the AI model or a second count of errors in the training set, after addition of at least one selected candidate feature, to obtain a second measurement, and (c) subtracting the second measurement from the first measurement to determine the improvement.

FIGS. 3A-3C are exemplary screenshots 300, 330, 360, respectively, of the user device 102 of FIG. 1 that illustrates automatically generating selected candidate features for automated feature suggestions for a customer support AI model according to some embodiments herein. As an example, a classification of customer support tickets in retail is described. The example uses a publicly available dataset to build an AI model “MODEL1”. As this model is built, the model learns one or more categories and eventually categorizes customer support tickets into one of the categories below one or more categories. The output of the AI model “MODEL1” may follow a schema. The one or more categories may include a customer support category, a payment category, a payment issue category, a payment method category, a feedback category, a complaint category, a review category, an order category, a change order category, a track order category, a place order category, and a cancel order category.

FIG. 3A illustrates a first exemplary screen 300 that includes a user interface of the user device 102 that displays a list of suggestions to improve an AI model “MODEL1” that is stored at a location “username/repository/models”.

The first exemplary screen 300 includes a model name 302 which is “username/repository/models”, a selected prediction class 304 that relates to a class of prediction determined by the AI model “MODEL1”, a score box 306 that displays a predicted score of the AI model “MODEL1” for the class, a document description box 312 that shows “can you tell me about your payment methods”. The predicted score of the AI model “MODEL1” is 17.60%. The first exemplary screen 300 further includes a reviewing pane 308 comprising suggestions to improve the AI model “MODEL1” and one or more errors. The reviewing pane 308 includes one or more suggested ML features 310, and an action pane 312 that has one or more buttons to block a suggested ML feature upon receiving an input from the user 108. When the AI model “MODEL1” produces an error, the computing device 150 finds one or more words in training documents that correlate with the error and display the one or more words in the one or more suggested ML features 310. In the example, the words that may be found in relation with the errors and are displayed in the one or more suggested ML features 310 include “issue”, “methods”, “payment”, “view”, “your”. In an embodiment, the one or more suggested ML features may be sorted with respect to a correlation with the error.

The one or more suggested ML features 310 are clickable based on input from the user 108, upon which a create new dictionary feature pop-up appears on the user device 102, which is described in FIG. 3B.

FIG. 3B illustrates a second exemplary screen 330 that includes the user interface of the user device 102 that displays the create new dictionary feature screen 320 over the first exemplary screen 330 when the user 108 clicks on the suggested ML feature “methods”. The create new dictionary feature screen 320 includes a feature name 322 that describes a name of a feature, an add phrases box 324 that may be used to capture input from the user 108 to manually add a phrase to the feature, a phrases box 326 that includes a list of phrases or concepts that are generated from the training data or selected from the repository of curated features. For example, the computing device 150 may generate the phrases or concepts such as “Issue: error, issues, incident, accident, outage, problem, exception, obstacle, attack, anomaly, experience”, “Payment: paying, billing, delivery, payments, purchasing, installments, expense, imbursement”, “Complaint: grievance, claim, lawsuit, complain, complaints, protest, petition, complainant, comment, request, remedy, response, suit, statement, plea, case, charge, dispute”, and “Lodge: lodge, file, write, filing, submit, submitting, lodging”.

The create new dictionary feature screen 320 further includes an add button 328 that causes addition of the feature to the AI model “MODEL1”. The user 108 may remove a phrase which is an outlier from the list of phrases by providing an input in the phrases box 326. When the user 108 clicks on the add button 328, the suggested ML feature “methods” is added to the AI model “MODEL1”, which is described in FIG. 3C.

FIG. 3C illustrates a third exemplary screen 360 that includes the user interface of the user device 102 that illustrates improvement in the objective function of the AI model “MODEL1” caused by addition of the suggested ML feature “methods” to the AI model “MODEL1”. After addition of the suggested ML feature “methods” to the AI model “MODEL1”, the one or more errors are resolved and the AI model “MODEL1” makes better predictions. By addition of the suggested ML feature to the AI model “MODEL1”, the AI model “MODEL1” learns a concept of payment methods and makes better predictions. The improvement in the objective function of the AI model “MODEL1” caused by the addition of the suggested ML feature is shown in the score box 306 to be increased to 75.91% from 17.60%, an improvement of 58.31%. In an embodiment, the machine learning algorithm that may re-rank the phrases obtained in the second exemplary screen with respect to the error. Re-ranked concepts may be displayed to the user 108 for validation.

In an alternative embodiment, a goal of the AI model 162 may be to classify web pages that contain cooking recipes from web pages that do not. Existing features of the AI model 162 may be lists of nGrams that are related to recipes (lists of recipe terms, cooking verbs, vegetables, meats, cooking measures, etc.). For a plurality of such lists, a feature value for a feature i on a given document d may be computed as Log(1+f_{td}) where f_{td} is the number of occurrences of a term in the list i in document d divided by the length of the document (f_{td} and Log(1+f_{td}) are referred to as the term frequency and “log normalization” in the natural language literature. The examples are web pages either labeled as containing recipes (positive) or not containing recipes (negative). The objective function is defined by logistic regression over these features, and for the ML algorithm, Broyden-Fletcher-Goldfarb-Shanno (BFGS) algorithm may be used with some known regularization. It may be assumed that ML algorithm cannot correctly classify the examples in the training set given the provided features. If features are sparse and imperfect, this situation is bound to occur with even a small number of examples. The high degree of difficulty of the system to classify the training data triggers the initial feature selection module 202. Selecting the initial set of features may be performed from a large space of existing features. A valid example of such space is a set of all NGram of length less or equal to 3. An un-optimized version of selecting the initial set of features may be to add each of the NGram to an existing set of features of the AI model 162 and measure the improvement in the performance after addition of new features. The performance may be measured by measuring the objective function, counting the number of errors, or any other reasonable measurement of performance. The NGram may be sorted by the improvement, and the top candidates may be displayed as shown in the screenshot 300. All the NGram may not appear in the training set and may not have impact on the objective function of the AI model 162. Therefore, if there are N words in the training data, there are only 3N NGram in the training data that need to be tested. The difference of the objective function resulting by the addition of a new feature may be approximated by measuring a derivative (or higher derivative) of the objective function around a corresponding of weight 0 (if the weight is 0, the feature is not present). A gradient (or higher derivatives of the objective function) with respect to each of the candidate features then provides an estimate of how beneficial that feature is likely to be may be computed as Log(1+f_{td}) where f_{td} is the number of occurrence of a term in the list i in document d divided by the length of the document (f_{td} and Log(1+f_{td}) are referred to as the term frequency and “log normalization” in the natural language literature. The examples are web pages either labeled as containing recipes (positive) or not containing recipes (negative). The objective function is defined by logistic regression over these features, and for the ML algorithm, Broyden-Fletcher-Goldfarb-Shanno (BFGS) algorithm may be used with some known regularization. It may be assumed that ML algorithm cannot correctly classify the examples in the training set given the provided features. If features are sparse and imperfect, this situation is bound to occur with even a small number of examples. The high degree of difficulty of the system to classify the training data triggers the initial feature selection module 202. Selecting the initial set of features may be performed from a large space of existing features. A valid example of such space is a set of all NGram of length less or equal to 3. An un-optimized version of selecting the initial set of features may be to add each of the NGram to an existing set of features of the AI model 162 and measure the improvement in the performance after addition of new features. The performance may be measured by measuring the objective function, counting the number of errors, or any other reasonable measurement of performance. The NGram may be sorted by the improvement, and the top candidates may be displayed as shown in the screenshot 300. All the NGram may not appear in the training set and may not have impact on the objective function of the AI model 162. Therefore, if there are N words in the training data, there are only 3N NGram in the training data that need to be tested. The difference of the objective function resulting by the addition of a new feature may be approximated by measuring a derivative (or higher derivative) of the objective function around a corresponding of weight 0 (if the weight is 0, the feature is not present). A gradient (or higher derivatives of the objective function) with respect to each of the candidate features then provides an estimate of how beneficial that feature is likely to be.

The features suggested by selecting the initial set of features may be too crude or too specific to the training data. For example, if the word “is” occurs slightly more frequently in the false negatives than in the rest of the data set, it will become a suggested feature. The initial set of features may need to be filtered. The initial set of features may be augmented with synonyms. A context may be obtained from where the synonym may occur in the training set. In an embodiment, for text, the augmenting from unsupervised data may include using inverse document frequency (IDF), synonyms, curated lists, etc. Information external to the training set may be used to filter and alter the suggested features. If the training data has a few errors, there may be many NGrams or group of NGram that may fix these errors. In a cooking recipe example, the suggested features may include following 2 lists [“10”, “20”, “30”, . . . ] and [“gardening”, “garden”, “flower”, “seeds”, . . . ]. A quick inspection of errors may reveal that the first list is accidental, even though it may be more useful in reducing the objective function on the training data. The quick inspection may reveal that some gardening pages are confused as positives with recipe page when the contain words like “how to grow delicious tomatoes”, “herbs gardening”, or “gourmet recipes from your own garden”. Adding a list of gardening terms may immediately fix not only the existing errors but also prevent future confusion between gardening pages and recipe pages.

FIG. 4 is an exemplary screenshot 400 of the user device 102 of FIG. 1 that illustrates creating a new composite feature according to some embodiments herein. The screenshot 400 illustrates a form-based user interface 402 that receives input from the user 108 on a name of the feature 404, a sub-category of the feature, a context type, a first feature 406 and a second feature 410. A composite feature may be generated, where the composite feature includes a combination of the first feature 406 and the second feature 410. A subset of the composite feature may be automatically selected and augmented to obtain suggested features based on a source of knowledge that is external to the training data. The suggested features may be presented to the user based on an improvement in the objective function of the AI model caused by addition of the suggested features in the AI model. The suggested features may be validated based on a user input to obtain one or more validated suggested features, where the one or more validated suggested features are validated by the user to improve the generalization of the AI model. The validated suggested features may be added to the AI model to improve the generalization of the AI model.

As an example, a goal of the AI model 162 may be to classify web pages that contains cooking recipes from web pages that do not. Existing features of the AI model 162 may be lists of nGrams that are related to recipes (lists of recipe terms, cooking verbs, vegetables, meats, cooking measures, etc.). For a plurality of such lists, a feature value for a feature i on a given document d may be computed as Log(1+f_{td}) where f_{td} is the number of occurrence of a term in the list i in document d divided by the length of the document (f_{td} and Log(1+f_{td}) are referred to as the term frequency and “log normalization” in the natural language literature. The examples are web pages either labeled as containing recipes (positive) or not containing recipes (negative). The objective function is defined by logistic regression over these features, and for the ML algorithm, Broyden-Fletcher-Goldfarb-Shanno (BFGS) algorithm may be used with some known regularization. It may be assumed that ML algorithm cannot correctly classify the examples in the training set given the provided features. If features are sparse and imperfect, this situation is bound to occur with even a small number of examples. The high degree of difficulty of the system to classify the training data triggers the initial feature selection module 202. Selecting the initial set of features may be performed from a large space of existing features. A valid example of such space is a set of all NGrams of length less or equal to 3. An un-optimized version of selecting the initial set of features may be to add each of the NGrams to an existing set of features of the AI model 162 and measure the improvement in the performance after addition of new features. The performance may be measured by measuring the objective function, counting the number of errors, or any other reasonable measurement of performance. The NGrams may be sorted by the improvement, and the top candidates may be displayed as shown in the screenshot 300. All the NGrams may not appear in the training set and may not have impact on the objective function of the AI model 162. Therefore, if there are N words in the training data, there are only 3N NGram in the training data that need to be tested. The difference of the objective function resulting by the addition of a new feature may be approximated by measuring a derivative (or higher derivative) of the objective function around a corresponding of weight 0 (if the weight is 0, the feature is not present). A gradient (or higher derivatives of the objective function) with respect to each of the candidate features then provides an estimate of how beneficial that feature is likely to be.

The features suggested by selecting the initial set of features may be too crude or too specific to the training data. For example, if the word “is” occurs slightly more frequently in the false negatives than in the rest of the data set, it will become a suggested feature. The initial set of features may need to be filtered. The initial set of features may be augmented with synonyms. A context may be obtained from where the synonym may occur in the training set. In an embodiment, for text, the augmenting from unsupervised data may include using inverse document frequency (IDF), synonyms, curated lists, etc. Information external to the training set may be used to filter and alter the suggested features. If the training data has a few errors, there may be many NGrams or group of NGram that may fix these errors. In a cooking recipe example, the suggested features may include following 2 lists [“10”, “20”, “30”, . . . ] and [“gardening”, “garden”, “flower”, “seeds”, . . . ]. A quick inspection of errors may reveal that the first list is accidental, even though it may be more useful in reducing the objective function on the training data. The quick inspection may reveal that some gardening pages are confused as positives with recipe page when the contain words like “how to grow delicious tomatoes”, “herbs gardening”, or “gourmet recipes from your own garden”. Adding a list of gardening terms may immediately fix not only the existing errors but also prevent future confusion between gardening pages and recipe pages.

In some embodiments, the first formula may be automatically generated based on the first user-validated label that corresponds to a first predefined category, the second user-validated label that corresponds to a second predefined category, and at least some of the plurality of raw data in the at least one column of the tabular data.

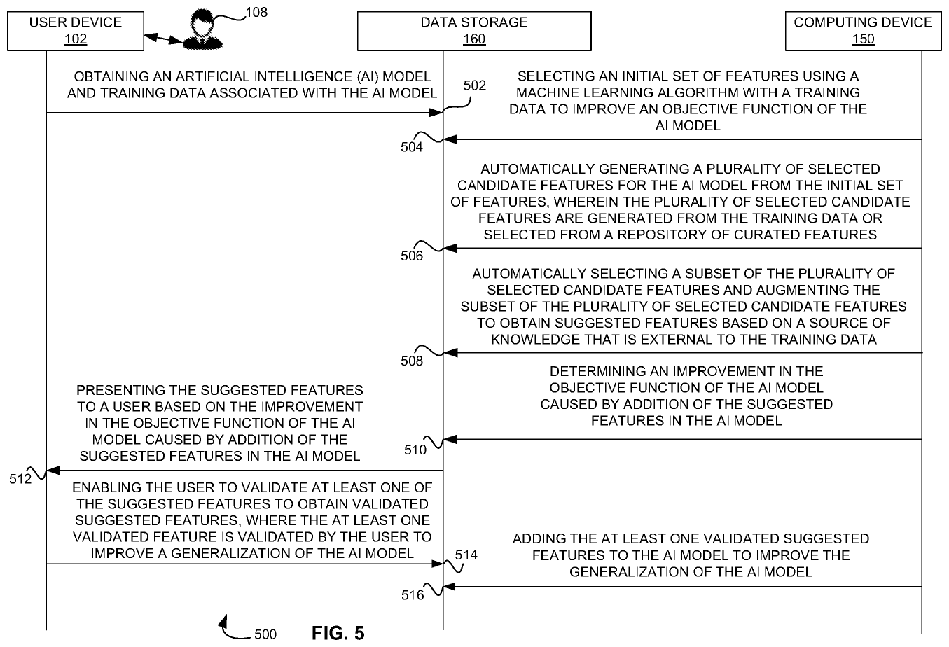

FIG. 5 is an interaction-type flow diagram that illustrates a method 500 of interactively improving a generalization of an AI model using automated feature suggestion with a user according to some embodiments herein. At step 502, the method 500 includes obtaining an AI model and training data associated with the AI model. At step 504, the method 500 includes selecting an initial set of features using a machine learning algorithm with a training data to improve an objective function of the AI model. At step 506, the method 500 includes automatically generating a plurality of selected candidate features for the AI model from the initial set of features, wherein the plurality of selected candidate features are generated from the training data or selected from a repository of curated features. At step 508, the method 500 includes automatically selecting a subset of the plurality of selected candidate features and augmenting the subset of the plurality of selected candidate features to obtain suggested features based on a source of knowledge that is external to the training data. At step 510, the method 500 includes determining an improvement in the objective function of the AI model caused by addition of the suggested features in the AI model. At step 512, the method 500 includes presenting the suggested features to the user based on the improvement in the objective function of the AI model caused by addition of the suggested features in the AI model. At step 514, the method 500 includes enabling the user to validate the suggested features to obtain at least one validated suggested feature. At step 516, the method 500 includes adding the at least one validated suggested feature to the AI model to improve the generalization of the AI model.

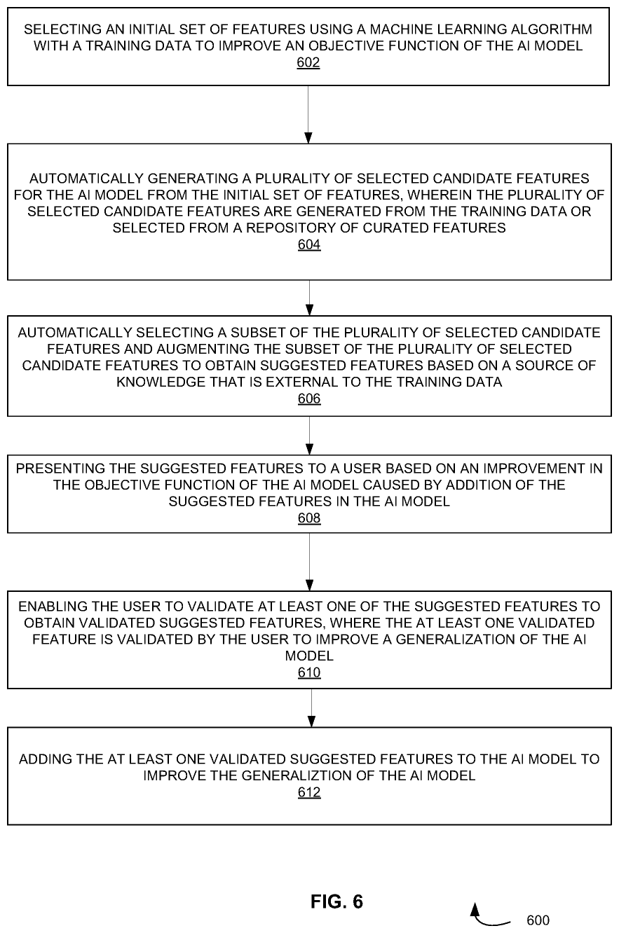

FIG. 6 is a flow diagram 600 that illustrates a method for interactively improving a generalization of an AI model using automated feature suggestion with a user according to some embodiments herein. At step 602, the method 600 includes selecting an initial set of features using a machine learning algorithm with a training data to optimize an objective function of the AI model. At step 604, the method 600 includes automatically generating a plurality of selected candidate features for the AI model from the initial set of features, wherein the plurality of selected candidate features are generated from the training data or selected from a repository of curated features. At step 606, the method 600 includes automatically selecting a subset of the plurality of selected candidate features and augmenting the subset of the plurality of selected candidate features to obtain suggested features based on a source of knowledge that is external to the training data. At step 608, the method 600 includes presenting the suggested features to the user based on the improvement in the objective function of the AI model caused by addition of the suggested features in the AI model. At step 610, the method 600 includes enabling the user to validate at least one of the suggested features to obtain at least one validated suggested feature, wherein the at least one validated suggested feature is validated by the user to improve the generalization of the AI model. At step 612, the method 600 includes adding the at least one validated suggested feature to the AI model to improve the generalization of the AI model.

The method validates the suggested features based on the user input to obtain validated suggested features allows the user to inject domain knowledge to help the AI model generalize, instead of fitting a distribution of the training data into the AI model. The method enables generating feature suggestions that are combinations of existing features. Further, the user input in the method is related to validating, thus saving the user from having to input examples or nGrams on their own.

In some embodiments, the AI model is interactively improved using automated composite feature suggestion, including (i) generating a plurality of composite features, wherein each of the plurality of composite features comprises a combination of at least a first feature and a second feature of the AI model, (ii) automatically selecting a subset of the plurality of composite features and augmenting the subset of the plurality of composite features to obtain suggested features, (iii) presenting the suggested features to the user based on an improvement in the objective function of the AI model caused by addition of the suggested features in the AI model, (iv) validating the suggested features based on a user input to obtain validated suggested features, and (v) adding the validated suggested features to the AI model to improve the objective function of in the AI model.

In some embodiments, the automatically selecting comprises discarding at least one composite feature of the plurality of composite features, wherein the at least one composite feature comprises the first feature and the second feature, if the first feature and the second feature do not satisfy a positional constraint with respect to each other, wherein the at least one composite feature comprises the first feature and the second feature.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

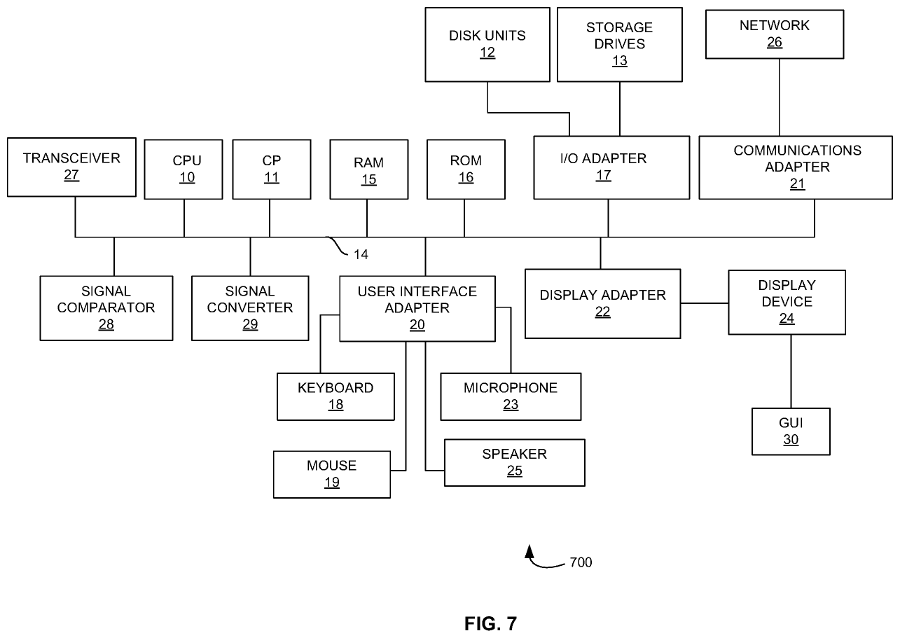

A representative hardware environment for practicing the embodiments herein is depicted in FIG. 7, with reference to FIGS. 1 through 6. This schematic drawing illustrates a hardware configuration of a server/computer system/user device in accordance with the embodiments herein. The user device includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The user device can read the inventive instructions on the program storage devices and follow these instructions to execute the methodology of the embodiments herein. The user device further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method of interactively improving a generalization of an artificial intelligence (AI) model using automated feature suggestion with a user, comprising:
selecting an initial set of features using a machine learning algorithm with a training data to improve an objective function of the AI model;
automatically generating a plurality of selected candidate features for the AI model from the initial set of features, wherein the plurality of selected candidate features are generated from the training data or selected from a repository of curated features;
automatically selecting a subset of the plurality of selected candidate features and augmenting the subset of the plurality of selected candidate features to obtain suggested features based on a source of knowledge that is external to the training data;
presenting the suggested features to the user based on the improvement in the objective function of the AI model caused by addition of the suggested features in the AI model;
enabling the user to validate at least one of the suggested features t to obtain at least one validated suggested feature, wherein the at least one validated suggested feature is validated by the user to improve the generalization of the AI model; and
adding the at least one validated suggested feature to the AI model to improve the generalization of the AI model.

2. The processor-implemented method of claim 1, wherein the automatically generating the plurality of selected candidate features is triggered if the AI model produces an error in classifying the training data based on a set of provided features.

3. The processor-implemented method of claim 1, wherein the improvement is determined by (a) measuring the performance of the objective function of the AI model or a first count of errors in the training set, before addition of at least one selected candidate feature, to obtain a first measurement, (b) measuring the performance of the objective function of the AI model or a second count of errors in the training set, after addition of at least one selected candidate feature, to obtain a second measurement, and (c) subtracting the second measurement from the first measurement to determine the improvement.

4. The processor-implemented method of claim 1, wherein the machine learning algorithm used to select the initial set of features produces errors in the training data before the validated suggested features are added to the AI model.

5. The processor-implemented method of claim 1, further comprising processing a rejection by the user to reject at least one of the suggested features to obtain at least one rejected suggested feature, wherein the rejected suggested feature is not added to the AI model, and the rejection of the rejected suggested feature is taken into account by the AI model for generating additional suggestions of features.

6. The processor-implemented method of claim 5, further comprising interactively validating the suggested features by the user by adding or rejecting the suggested features until no further errors are produced in the training data.

7. The processor-implemented method of claim 1, wherein the selected candidate features comprise nGrams that are filtered using unsupervised data that is selected based on at least one of an inverse document frequency method, synonyms of nGrams and the repository of curated features.

8. A processor-implemented method of interactively improving a generalization of an artificial intelligence (AI) model using automated composite feature suggestion with a user, comprising:
generating a plurality of composite features to improve an objective function of the AI model, wherein each of the plurality of composite features comprises a combination of at least a first feature and a second feature of the AI model;
automatically selecting a subset of the plurality of composite features and augmenting the subset of the plurality of composite features to obtain suggested features;
presenting the suggested features to the user based on an improvement in the objective function of the AI model caused by addition of the suggested features in the AI model;
enabling the user to validate at least one of the suggested features to obtain at least one validated suggested feature, wherein the at least one validated suggested feature is validated by the user to improve the generalization of the AI model; and
adding the at least one validated suggested feature to the AI model to improve the generalization of the AI model.

9. The processor-implemented method of claim 8, wherein the automatically selecting comprises discarding at least one composite feature of the plurality of composite features if the first feature and the second feature do not satisfy a positional constraint with respect to each other, wherein the at least one composite feature comprises the first feature and the second feature.

10. A system for interactively improving a generalization of an artificial intelligence (AI) model using automated feature suggestion with a user, comprising: a processor and a non-transitory computer readable storage medium storing one or more sequences of instructions, which when executed by the processor, performs a method comprising:
selecting an initial set of features using a machine learning algorithm with a training data to improve an objective function of the AI model;
automatically generating a plurality of selected candidate features for the AI model from the initial set of features, wherein the plurality of selected candidate features are generated from the training data or selected from a repository of curated features;
automatically selecting a subset of the plurality of selected candidate features and augmenting the subset of the plurality of selected candidate features to obtain suggested features based on a source of knowledge that is external to the training data;
presenting the suggested features to the user based on the improvement in the objective function of the AI model caused by addition of the suggested features in the AI model;
enabling the user to validate at least one of the suggested features to obtain at least one validated suggested feature, wherein the at least one validated suggested feature is validated by the user to improve the generalization of the AI model; and
adding the at least one validated suggested feature to the AI model to improve the generalization of the AI model.

11. The system of claim 10, wherein the automatically generating the plurality of selected candidate features is triggered if the AI model produces an error in classifying the training data based on a set of provided features.

12. The system of claim 10, wherein the improvement is determined by (a) measuring the performance of the objective function of the AI model or a first count of errors in the training set, before addition of at least one selected candidate feature, to obtain a first measurement, (b) measuring the performance of the objective function of the AI model or a second count of errors in the training set, after addition of at least one selected candidate feature, to obtain a second measurement, and (c) subtracting the second measurement from the first measurement to determine the improvement.

13. The system of claim 10, wherein the machine learning algorithm used to select the initial set of features produces errors in the training data before the validated suggested features are added to the AI model.

14. The system of claim 10, further comprising processing a rejection by the user to reject at least one of the suggested features to obtain at least one rejected suggested feature, wherein the rejected suggested feature is not added to the AI model, and the rejection of the rejected suggested feature is taken into account by the AI model for generating additional suggestions of features.

15. The system of claim 10, further comprising interactively validating the suggested features by the user by adding or rejecting the suggested features until no further errors are produced in the training data.

16. The system of claim 10, wherein the selected candidate features comprise nGrams that are filtered using unsupervised data that is selected based on at least one of an inverse document frequency method, synonyms of nGrams and the repository of curated features.

17. The system of claim 10, further comprising interactively improving the generalization of the AI model using automated composite feature suggestion with the user, comprising:
generating a plurality of composite features to improve the objective function of the AI model, wherein each of the plurality of composite features comprises a combination of at least a first feature and a second feature of the AI model;
automatically selecting a subset of the plurality of composite features and augmenting the subset of the plurality of composite features to obtain suggested features;
presenting the suggested features to the user based on an improvement in the objective function of the AI model caused by addition of the suggested features in the AI model;
enabling the user to validate at least one of the suggested features to obtain at least one validated suggested feature, wherein the at least one validated suggested feature is validated by the user to improve the generalization of the AI model; and
adding the at least one validated suggested feature to the AI model to improve the generalization of the AI model.

18. The system of claim 17, wherein the automatically selecting comprises discarding at least one composite feature of the plurality of composite features if the first feature and the second feature do not satisfy a positional constraint with respect to each other, wherein the at least one composite feature comprises the first feature and the second feature.

19. One or more non-transitory computer readable storage mediums storing one or more sequences of instructions, which when executed by one or more processors, causes a method of interactively improving a generalization of an artificial intelligence (AI) model using automated feature suggestion with a user, the method comprising:
selecting an initial set of features using a machine learning algorithm with a training data to improve an objective function of the AI model;
automatically generating a plurality of selected candidate features for the AI model from the initial set of features, wherein the plurality of selected candidate features are generated from the training data or selected from a repository of curated features;
automatically selecting a subset of the plurality of selected candidate features and augmenting the subset of the plurality of selected candidate features to obtain suggested features based on a source of knowledge that is external to the training data;
presenting the suggested features to the user based on the improvement in the objective function of the AI model caused by addition of the suggested features in the AI model;
enabling the user to validate at least one of the suggested features to obtain at least one validated suggested feature, wherein the at least one validated suggested feature is validated by the user to improve the generalization of the AI model; and
adding the at least one validated suggested feature to the AI model to improve the generalization of the AI model.

20. The one or more non-transitory computer readable storage mediums storing the one or more sequences of instructions of claim 19, wherein the improvement is determined by (a) measuring the performance of the objective function of the AI model or a first count of errors in the training set, before addition of at least one selected candidate feature, to obtain a first measurement, (b) measuring the performance of the objective function of the AI model or a second count of errors in the training set, after addition of at least one selected candidate feature, to obtain a second measurement, and (c) subtracting the second measurement from the first measurement to determine the improvement.

21. The one or more non-transitory computer readable storage mediums storing the one or more sequences of instructions of claim 19, further comprising interactively improving an AI model using automated composite feature suggestion, comprising:
generating a plurality of composite features to improve the objective function of the AI model, wherein each of the plurality of composite features comprises a combination of at least a first feature and a second feature of the AI model;
automatically selecting a subset of the plurality of composite features and augmenting the subset of the plurality of composite features to obtain suggested features;
presenting the suggested features to the user based on an improvement in the objective function of the AI model caused by addition of the suggested features in the AI model;
enabling the user to validate at least one of the suggested features to obtain at least one validated suggested feature, wherein the at least one validated suggested feature is validated by the user to improve the generalization of the AI model; and
adding the at least one validated suggested feature to the AI model to improve the generalization of the AI model.

22. The one or more non-transitory computer readable storage mediums storing the one or more sequences of instructions of claim 19, wherein the selected candidate features comprise nGrams that are filtered using unsupervised data that is selected based on at least one of an inverse document frequency method, synonyms of nGrams and the repository of curated features.
